(19) United States
(12) Patent Application Publication
(10) Pub. No.: US 2013/0060841 A1
(43) Pub. Date: Mar. 7, 2013

(54) METHOD OF SYNCHRONISING DIGITAL MEDIA CONTENT

(71) Applicants: Mark Knight, Surrey (GB); Philip Sant, London (GB); Christopher Evans, London (GB); Matthew White, London (GB)

(72) Inventors: Mark Knight, Surrey (GB); Philip Sant, London (GB); Christopher Evans, London (GB); Matthew White, London (GB)

(73) Assignee: Omnifone Ltd., London (GB)

(21) Appl. No.: 13/514,618

(22) PCT Filed: Dec. 9, 2010
(86) PCT No.: PCT/GB2010/052064

§ 371 Date: Nov. 13, 2012

(30) Foreign Application Priority Data
Dec. 9, 2009 (GB) 0921559.1

(51) Int. Cl. G06F 15/16

(52) U.S. Cl. 709/203

(57) ABSTRACT

Synchronising digital media content to a device is achieved using the following steps: (a) identifying a digital media collection linked to a given user; (b) analysing the content of the digital media collection to derive a “taste signature” for that user; (c) identifying, based on the “taste signature” analysis, the priority order in which media content files are to be provided to the device during a synchronisation; (d) providing one or more media content files to the device during the synchronisation.

### BACKGROUND OF THE INVENTION

1. Field of the Invention

This invention relates to a method for synchronising digital media content.

2. Description of the Prior Art

Synchronisation of data from one computing device to another is considered to be a simple procedure of examining two sets of files and copying files between the two devices according to which was most recently modified, with the added requirement for recording the file structure at the time of the last synchronisation in order to detect and handle deletions and, in more sophisticated approaches, file moving and renaming.

The problem with that current approach, which is solved by the present invention, is that it takes no account of the way in which the end user interacts with the files being synchronised, and consequently is, at root, a simple all-or-nothing process: devices are either synchronised or they are not, and there is, for example, no concept of a “partially synchronised” device pair.

With regard to digital media files, this traditional approach to synchronisation has led to media playback devices—any device which is capable of playing any digital media content—being treated in the same manner as digital address books, where each is an independent cache of data that is synchronised with others at intervals.

### SUMMARY OF THE INVENTION

The invention is a method for synchronising digital media content to a device, comprising the following steps:
(a) identifying a digital media collection linked to a given user;
(b) analysing the content of the digital media collection to derive a “taste signature” for that user;
(c) identifying, based on the “taste signature” analysis, the priority order in which media content files are to be provided to the device during a synchronisation;
(d) providing one or more media content files to the device during the synchronisation.

The synchronisation approach adopted in an implementation by the present invention is therefore to consider each media playback device to be a repository for a subset of the user's overall media content collection. Rather than attempting to synchronise the entire media content collection with every device, which is what traditionally is meant by device synchronisation, a more intelligent approach may then be adopted, permitting specific portions of the user's collection to be supplied to specific devices based on an analysis of the user's “taste signature” and, in a specific implementation, the interactions with his media content collection together with the specific device's capabilities and an analysis of the user's interactions with that device.

What is provided by the present invention is therefore a mechanism for analysing the consumer's existing tastes and using the results of that analysis to identify both media content which is likely to appeal to that individual and also like-minded individuals who share some or all of that individual's taste in media content.

Such an approach circumvents the limitations of the current approach in the art to device synchronisation and permits the optimisation of the synchronisation process in different and more useful ways to those available to the current art.

Definitions

For convenience, and to avoid needless repetition, the terms “music” and “media content” in this document are to be taken to encompass all “media content” which is in digital form or which it is possible to convert to digital form—including but not limited to books, magazines, newspapers and other periodicals, video in the form of digital video, motion pictures, television shows (as series, as seasons and as individual episodes), images (photographic or otherwise), music, computer games and other interactive media.

Similarly, the term “track” indicates a specific item of media content, whether that be a song, a television show, an eBook or portion thereof, a computer game or any other discreet item of media content.

The terms “playlist” and “album” are used interchangeably to indicate collections of “tracks” which have been conjoined together such that they may be treated as a single entity for the purposes of analysis or recommendation.

The verb “to listen” is to be taken as encompassing any interaction between a human and media content, whether that be listening to audio content, watching video or image content, reading books or other textual content, playing a computer game, interacting with interactive media content or some combination of such activities.

The terms “user”, “consumer”, “end user” and “individual” are used interchangeably to refer to the person, or group of people, whose media content “listening” preferences are analysed and for whom recommendations are made.

The term “taste” is used to refer to a user's media content “listening” preferences. A user's “taste signature” is a computer-readable description of a user's taste, as derived during the process disclosed for the present invention.

The term “recommendations” refers to media content items (“tracks”, “playlists” and “albums”) which are identified - using the mechanisms disclosed in the present invention, in Omnifone Patent Application “Nearest Neighbour & Digital Content Recommendation Techniques” PCT/GB2010/051113 or by any other compatible mechanisms—as matching or complementing the user's taste in media content.

The terms “media collection” and “music collection” and similar terms are used interchangeably to refer to an actual or notional set of “music tracks” which are owned by the user either directly—in the form of physical media or downloaded or encoded digital media files—or indirectly, such as by being bookmarked as “favourite” tracks or within playlists or by some other mechanism in a music subscription service or an media content catalogue. Any media content which is directly linked to the user by such mechanisms is considered to be part of that user's “music collection”.

The terms “device” and “media player” are used interchangeably to refer to any computational device which is capable of playing digital media content, including but not limited to MP3 players, television sets, home computer systems, mobile computing devices, games consoles, handheld games consoles, vehicular-based media players or any other applicable device or software media player on such a device.

Throughout this document, the masculine includes the feminine, and vice versa, and the singular includes the plural, and vice versa.

Overview

The present invention discloses a mechanism whereby the media content (e.g. “music listening”) preferences of an individual may be analysed and the analysis be used to optimise the process of synchronising that user's device or devices with the user's music collection. The music collection may reside as a ‘master’ set on one or more devices, or be held on the cloud, or may be distributed across various devices and the cloud so that no single device includes a master set. We refer collectively to the repository of all places where there might be media content relevant to the user as the ‘media store’. Hence, this invention deals with optimising the process of synchronising a user's device with media content held on the ‘media store’.

The process disclosed by the present invention may be viewed, in the preferred implementation, as encompassing the following steps:
Identify the user's current media content collection;
Analyse the content of the said collection, deriving a “taste signature” for the user from that analysis;
Match the derived “taste signature” to other media content, both within the user's music collection and in any broader collection of media content to which the user has access via, for example, a music subscription service, and obtain “recommendations” for the user based on that matching process;
Analyse the ways in which the user interacts with the device to be synchronised;
Identify, based on the said analyses, both which media content files are to be provided to the said device and the priority order in which those files are to be provided;
Provide the file to the device.

Each stage of the process is described in turn in the sections which follow.

### BRIEF DESCRIPTION OF THE DRAWINGS

FIG. 1 of the drawings is a flow chart of the overall synchronisation process.

FIG. 2 shows the playlist reconstruction process.

### DETAILED DESCRIPTION

1. Identify and Analyse the User's Media Content

In the preferred embodiment, one or more of the techniques disclosed in this section may be used to identify a set of media content which is directly or indirectly linked to the device, and the owner thereof, which is to be synchronised. The said set, the user's “music collection”, is thus identified, in the preferred embodiment, both in its particulars and in its metadata, to the broadest extent possible.

1.1 Locate Media Content

Users are able to store media content in a variety of locations, some of which may be immediately accessible but others are less so. In order to ensure that an analysis of a user's taste is as useful as possible, such an analysis must be as comprehensive as possible, including as much of that user's media content as it is practical to access.

To meet that “comprehensive” standard, the content of the user's device must be examined to search for media content, looking in all common storage locations, including but not limited to one or more of the following:
File system locations, such as the “My Music”/“Music”, “My Video”/“Video” folders in Microsoft Windows. Users may also be prompted to identify any other of their media files to be included in this analysis.
Media player local databases for all identifiable media players which are installed on the device, such as iTunes, Windows Media Player, RealPlayer, VLC Player, DivX Player and so forth. For those players which maintain a database of media files, that database may be queried; for those player which maintain a “recently used files” list, that list may be inspected.
Physical media, such as media content stored on CDs, DVDs or other storage media owned by the user, may be examined as to their contents.
Online media stores. Users are able to store media content online, whether explicitly by storing actual files or indirectly by storing metadata describing files or by some combination of the two. Users may be prompted to identify and provide access to such online stores as they wish to include in the analysis, such as MySpace®, Last.fm®, Flickr®, Facebook®, Spotify®, Amazon® or any other online facility which permits the store or description of media content by end users.

When performing this “device sweep” it is important to exclude from the analysis any standard “preview” media content which is included with a device or media player, since such content is not indicative of the specific user's taste and therefore, with the possible exception of any such content which is specific to the service within which the present invention is being utilised, little to no purpose may be served by provisioning such content to the user's device(s). The term “device sweep” should not be interpreted as being limited to an analysis of a single device—in fact it includes a sweep of all devices and locations where relevant media files may be stored—i.e. all devices owned or accessed by the user (his ‘media store’) and also the media stores of others too—for example, friends who make recommendations to the user.

1.2 Gather Metadata

The purpose of the “device sweep” is to gather information about the user's existing media content and their listening preferences with respect to that media content—i.e. a “taste signature”. For that reason, the sweep needs to accumulate a considerable body of metadata concerning the media content files found. Such metadata may take several forms, including but not limited to one or more of the following:
Tags on media files, including explicitly embedded tags, such as ID3 tags used in MP3 files; associative tags, such as album artwork associated image files used by media players such as iTunes; and metadata stored in a media player's database, such as the genre classification of a track.
Physical media, such as media content stored on CDs, DVDs or other storage media owned by the user, may be examined as to their contents. For example, in one embodiment a user may be permitted to make an audio CD available to software which implements the present invention, whereupon the said CD could be read and its identifying signature matched against a database of such signatures in order to identify the track listing and associated metadata for that CD.
Playback metrics, where available. Some media players, such as iTunes and Windows Media Player, are capable of storing details of when, how often and for how long individual media content files have been played. In addition, some file systems provide clues to playback metrics—for example, by default NTSF stores a “last access time” against files which may be used as an indicator as to when a particular track was last played by the user.
DSP (“Digital Signal Processing”) techniques may be applied to media content in some instances, permitting the extraction of additional metadata about individual tracks. For example, if the device capabilities permit then DSP processing of audio files may be applied to provide details such as the mood, tempo and beat of a piece of music.
Track identification technology, such as TrackID or some other media content signature generation technology, may be applied to each track to generate a digital “signature” which can then be matched against a database of such signatures in order to identify the specific track, as a cross-check of other metadata and/or as a method of identifying tracks for which incomplete, corrupt or no metadata is located.
More generally, metadata relating to the digital media collection includes one or more of the following, whether or not that metadata is user-generated: titles; authors; composers; singers; publishers; genres; classifications; date-related information, including release dates; the locations of the digital media files; links between media, including playlists containing one or more digital media files; ratings; embedded tags; associated artwork; playback metrics; the duration of the digital media file; the size of the file, however measured; the file format; or any other descriptive metadata related to the digital media file.

One major purpose of performing this sweep is to identify the media content on the user's device (and, more generally, the user's media store and relevant third party media stores). The metadata for each track may also, in the preferred embodiment, be enriched by reference to a more comprehensive database against which metadata may be matched and additional information about each track retrieved.

As a result of the “device sweep”, a detailed description of the user's available media content (irrespective of where it is stored) has been constructed. That description may include such “metadata” items as the title, artists, duration, release name, beat, tempo, mood signature, playback metrics such as the time the track was last played by the user, associated artwork, ratings of the track by this user and/or any other information which may be available for analysis.

Where this user has previously registered a device with the service provided using the present invention then metadata may also have been obtained from the user's previously-registered device(s). In which case that previously-stored metadata is also, in the preferred embodiment, consolidated with the data obtained from the “device sweep” and the resultant collection of data used for analysis.

1.3 Linked Friends Weighting

In one example embodiment then, where a user has linked himself to one or more other users of a media content provision service within which the present invention is being utilised (i.e. the user has “linked friends” on that service) then the user's own metadata package may be augmented by those of his linked friends, suitably weighted to ensure that any recommendations made are primarily based upon this user's own media rather than that of his linked friends.

In the preferred embodiment, the weighting given to a user's linked friends' media content is configurable according to the type of linked friend.

For example, supposing that this user belongs to a service in which he has n other individuals linked as “close friends” and m linked as “linked friends” (counting only those linked friends for whom metadata is available within that service), where the “close friends” weighting is configured to N % and the “linked friends” weighting to M %. In such a case, the preferred embodiment would, when making recommendations, consolidate the linked friends' metadata to the user's such that the weight given to the user's metadata is (100−N−M)%, the weighting given to each “close friend” is (N/n)% and that to each “linked friend” (M/m)%. Where n or m are zero, the relevant component (N or M respectively) is omitted. Thus, a user with no close or linked friends would have his recommendations entirely based upon his own available media content.

1.4 Demographics as Metadata

The device type may also be used, in the preferred embodiment, as a source of metadata, as may other information such as the location of the user (to whatever granularity is available, from the user's country to their precise location as obtained via GPS or some measure in between the two, such as IP address analysis. Similarly, “device” may refer to a specific device or to a class of devices of a defined type, such as “portable game consoles” or “devices which can play DivX video” or “Games Console Model PQT-4381v2.12” or “devices which incorporate a BluRay player”).

Such information may be used to provide a demographic profile of purchasers/users of specific devices and/or inhabitants of given locales. To take a trivial example, such information would be used in one example embodiment to tend to recommend Spanish-language tracks or tracks which are popular in Spain to those users who are in that country. Hence, on synchronisation, those Spanish tracks could be given priority. So if a tourist were to be visiting Spain, then he might find that relatively little known Spanish tracks were given priority during synchronisation.

In addition, demographic information can, in the preferred embodiment, be obtained from a recommendations database which stores analyses of the musical preferences of all users of the service organised according to device type and/or location.

Device-specific metadata stored in the preferred embodiment includes information as to which tracks are most popular amongst users of a particular device in a particular region, with cross-references relating the demographics of average users of such devices to the popularity of tracks of users with such demographics (for example, where the average user of a particular device in the UK is determined to be an 18-25 year old male then the default tracks recommended for a user of that device, where no more specific information is available from a device sweep, would be those tracks which are generally popular on the service amongst 18-25 year old males in the UK).

The tastes of users within this user's own demographic group—as explicitly provided by the user and/or identified via the mechanisms outlined above—may, in the preferred embodiment, be used to augment recommendations made to this user using the same mechanism, mutatis mutandis, as disclosed in “Linked friends weighting” above.

1.5 Periodic Updates and Playback Metrics

In the preferred embodiment, the user's device (and their associated media store) is re-swept to locate new or updated media content and/or metadata at regular intervals which, in the preferred embodiment, are of configurable duration. Any changes detected are then used to provide more relevant updates.

Where the present invention is utilised within a service which permits user ratings and/or playback metrics to be recorded and communicated then such metrics are, in the preferred embodiment, used to update the recommendations provided to the user, such that future recommendations take account of the user's specific preferences.

1.6 Other Contributing Factors

In addition to the “device sweep”, demographic analysis, contributions from linked friends' taste metrics and the ongoing analysis of a user's playback metrics while using the service within which the present invention is utilised, sundry additional factors may also be utilised, in the preferred embodiment, to influence recommendations given to the user and hence influence synchronisation priority.

In the preferred embodiment, such factors include, but are not limited to:
The content of free text fields provided by the user, such as taglines and the titles given to user-created playlists within the service
Media content recommendations sent by this user to his linked friends
Media content recommendations received by this user from his linked friends and listened to, in whole or in part
Tracks marked as “favourites” or rated in some fashion by this user
Associated tracks within a pre-existing database. Where the service within which the present invention is being utilised has access to a database containing media content metadata then that metadata may be used, directly or indirectly, to feed into the recommendations process by providing associations between tracks.
Externally identified associations. In one embodiment an automated or manual analysis of articles, online or otherwise, about multimedia content may indicate a strong correlation between two or more artists, tracks or other related metadata. Such correlations may similarly feed into the recommendations process.

Such considerations, and any others which are applicable, may be used, in the preferred embodiment, to increase or decrease the weightings given to individual tracks when performing the analysis to locate tracks and “nearest neighbours” (users who share the same taste as this user) to recommend to this user.

1.7 Group Considerations

Up to this point, the disclosure of the present invention has been concerned with individual users rather than groups of users. When considering groups, the preferred embodiment consolidates the metadata of individuals within each group into a single collection of metadata and makes use of that combined metadata for analysis and recommendation purposes.

That consolidation, in the preferred embodiment, is performed in two stages:
Identify the frequency with which tracks are seen within the group (i.e. in a group of 5 individuals which tracks appear in the libraries of all 5 individuals, which in 4, which in 3, and so forth).
Weight each track's contribution to the overall group taste signature according to that identified frequency, such that the more commonly shared tracks within the group contribute a greater weight to the recommendations given to that group.

In the case of group recommendations, the linked friends of individual group members do not contribute to the overall weighting of tracks for the purposes of making recommendations of media content or of individuals with shared tastes in media.

1.8 Empty Devices

In some instances, such as on first use, it may not be possible to perform a device sweep of a user's media files.

For example, this may occur where there are no identifiable media files on the device and this user has not previously registered a device with the service within which the present invention is being utilised and the user has no linked friends within that service (or no such registered devices or linked friends can be identified due to, for example, a poor quality or absent network connection).

In such a case, recommendations may still be made based on demographic metadata alone, as disclosed above in “Demographics as Metadata”.

In the preferred embodiment, such “blank device profiles” are regularly pre-calculated for appropriate locales (such as countries or regions within a country or whatever other granularity is required) to assist with loading recommendations for new blank devices of that type.

2 Synchronising Unidentified Tracks

There may be media content items (“tracks”) which could not be identified automatically during the “device sweep” phase. Such items may, in an example embodiment, be referred to the user for later definitive identification. In another example embodiment, such unidentified items may be tagged by the system for further analysis at a later point.

Such unidentified media content may also, nonetheless, be synchronised across the user's device(s). In the preferred embodiment, the said unidentified content would be transcoded (converted as to their media content encoding format) to file formats appropriate to the user's other device(s), where necessary, and the transcoded versions of the said files transferred to a location from which they may be provisioned to the said other devices. In another embodiment, the process may be inverted—that is, the files transferred to a storage location where they are then transcoded to suitable formats, if necessary, before being made available for provisioning to the user's other device(s).

In either approach, the said storage facility is, in the preferred embodiment, both remotely located and accessible via a network connection (such as the internet or a wireless network) to the user's device(s) AND the said stored content is “locked” (by encryption or some other suitable approach) to ensure that only the originating user is permitted access to that stored content.

One example embodiment may identify where unidentified files from different users actually encode the same media content and use that information as an aid to identifying files, by ensuring that if/when one such media content file is positively identified then other such files are automatically also identified, tagged with the appropriate metadata and relocated, where possible within the applicable licensing laws and agreements, from the secure storage facility (the “locker”) to more general usage.

One example embodiment may identify where unidentified files from different users actually encode the same media content and use that information to avoid duplication of content within the “locker” by making the same file available to both users, where the applicable law permits such action to be taken.

3 Analyse User-Device Interaction

In addition to analysing the user's music collection to derive a metadata based “taste signature”, in the preferred embodiment the present invention also analyses the way in which the user interacts with that device, in terms of the specific user under consideration and/or in terms of the average user of such a device.

Elements considered include one or more of the following:
Which areas of the device's user interface the user utilises most often. See “Synchronisation of Channels” for additional information concerning this consideration.
In the case of a user who has previously registered and interacted with tracks (or “channels”, as disclosed above) on other device(s) then the user's interactions with media content on those other devices may be used as additional metadata to weight recommendations for the current device.
The demographics of the “typical” user of that device type (i.e. of that specific device or of the class of devices of which it forms a part) may also be taken into account, as disclosed earlier in “Demographics as Metadata”
Which tracks the user has specifically requested to be added to the device
In the case of “stale” users who would otherwise have their content synchronised but who never actually consume or experience the synchronised content then, in the preferred embodiment, synchronisation events are automatically switched off after a configurable period of lack of application use and/or content playback. Automatic synchronisation is automatically restarted on next application use and will remain in place until the user becomes “stale” again.
an analysis of metadata about the user, comprises one or more of the user's: age; location; income; religious beliefs or absence thereof; political leanings; education level; occupation; gender; sexuality; social class classification, however defined or derived; hobbies; other devices used by the user; the user's interactions with one or more devices; or any other relevant metadata concerning the user.

The present invention also takes account, in its preferred embodiment, of the capabilities of the device. Elements considered include one or more of the following:
Where a given track is located in different parts of the user interface of the device simultaneously (for example, if the said track appears in multiple channels within the device's user interface) then, in the preferred embodiment, that track may be weighted for recommendation purposes in order to ensure that the device's user interface is populated as rapidly as possible.
Different devices have capabilities as to the format of media content files which they are able to play. For example, if a device has a screen display with a resolution of 200×150 then providing that device with a video at a much higher resolution would be profligate, hence any provisioned video would, in the preferred embodiment, first be transcoded to suit the device's capabilities. Similarly, devices vary as to the file formats which they are capable of handling and the DRM protection systems which they are able to employ. In the preferred embodiment, the present invention maintains such device capability metadata and ensures that the appropriate format is used to provision each device type.
The storage capacity of the device is also a factor in determining how much data can be transferred to the said device. When a device's storage area becomes full then recommendations produced by the analysis discussed in this document (and detailed in Omnifone Patent Application “Nearest Neighbour & Digital Content Recommendation Techniques” PCT/GB2010/051113 or by any other compatible mechanisms may, in the preferred embodiment, be used to determine the order in which media content may be removed from the device and replaced with new media content.
Where a device is capable of reporting useful information about its environment then that information may be utilised to assist in the scheduling of synchronisation, where applicable. For example, in the preferred embodiment where a device reports that it is currently in its docking or charging station then synchronisation of large files may be undertaken on the basis that in such a state the device is likely to remain consistently connected to the network for a considerable period of time.
Where a device is battery-powered and is able to report the battery status to the client application then, in the preferred embodiment, synchronisation may be performed only if the battery life is above a certain, customisable threshold.
The device's location—where available via such mechanisms as IP address translation, GPS positioning, user reported location or other appropriate mechanisms—may be used to weight recommendations made as well as to assist in determining the type and speed of network connection available to the device where such data is not otherwise available.
And generally playback metrics obtained from analysing the ways in which the user interacts with the device to be synchronised and those playback metrics include metadata detailing one or more of: when the user has played or viewed the digital media file; where the user has played or viewed the digital media file; on which device or devices the user has played or viewed the digital media file; when the digital media file was made available to the user; how often the user has played or viewed the digital media file or any other metadata concerning the user's interactions with the digital media file.

3.1 Device Connection Properties

The properties of a particular device's network connection are utilised, in the preferred embodiment, to influence recommendations (based, for example, on file size) and/or determine the timing as to when synchronisation takes place. Elements considered, in the preferred embodiment, include one or more of:
Available bandwidth. The bandwidth available to a device is a consideration when determining the size of files which may be provisioned to that device, and hence may be used to weight recommendations in favour of smaller files (whether in terms of shorter lengths or more efficient encoding techniques which are more appropriate for a given device) where necessary
Availability of Connection. The type and reliability of the device's network connection is used to influence the timing of synchronisation events.
Where a device reports that it is currently in its docking or charging station then synchronisation of large files may be undertaken on the basis that in such a state the device is likely to remain consistently connected to the network for a considerable period of time.
Where a device and connection type permits, the Back Channel of the bearer signal may, in the preferred embodiment, be utilised to send data to the server of whichever service within which the present invention is being utilised.
The connection history of a device may be used to influence scheduling of synchronisation. For example, user movement may be detectable via analysis of the device's connection history by, in one embodiment, an analysis of the IP address(es) reported by the device to a media content server over time. For example, a mobile device may show a pattern of connecting to a particular wireless network for a significant period of several hours followed by connections to various other wi-fi networks for varying periods and then a return to the original wireless network.

In the preferred embodiment, such an analysis would indicate that the said original wireless network is the user's “home network” and would permit downloads to (and/or uploads from) the device to be scheduled for those times when the user's device is determined to have its most reliable and/or fastest network connection.
Metadata concerning network congestion (resulting in slow or unreliable connections) in the locale within which the device is operating. In the preferred embodiment, this data may be both directly measured and inferred based on locale, network provider and time zone data.
Statistical data concerning average connection time for this device type, from demographic analysis, may be used to augment user-specific data where appropriate. As, for example in the preferred embodiment, where an individual user has not yet built up sufficient connection history data to permit a more personalised analysis.

In one example embodiment, the device has a reliable network connection only at specific times of day, as determined from statistical data and/or analysis of the connection activity of a specific user. In such a case, synchronisation—downloads, uploads or both—of larger files may be deferred (using, in the preferred embodiment, a download queue system) until a specifically scheduled time rather than happening on an ad hoc basis throughout the day.

4 Synchronise the Device with the Service

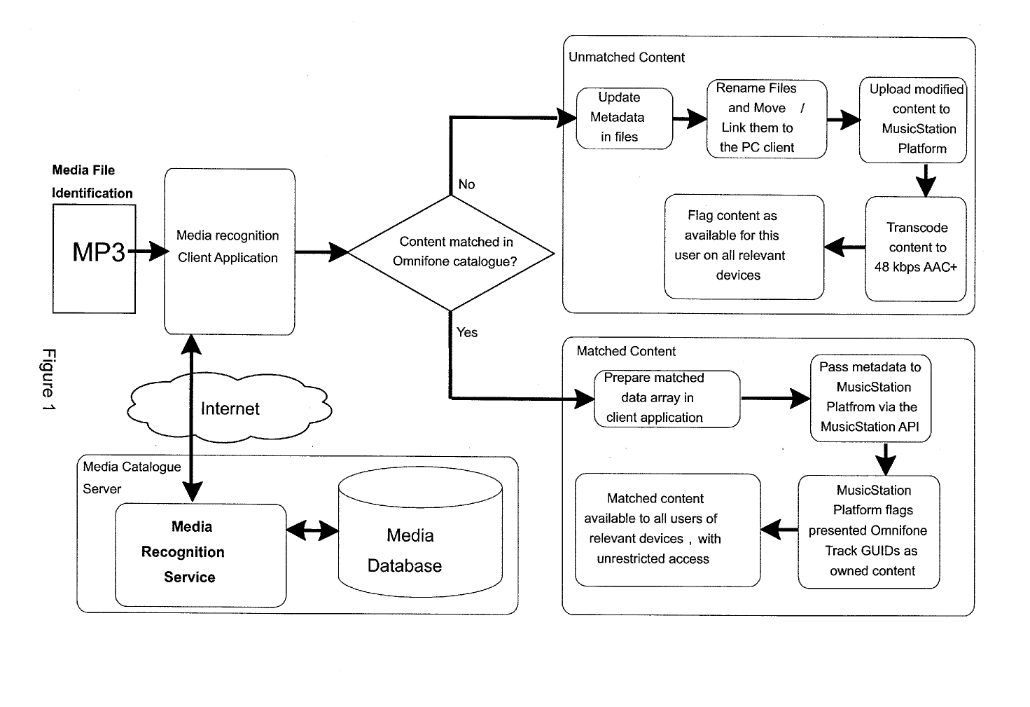

After the content analysis is complete, the process of synchronising the user's music collection with the service within which the present invention is utilised two distinct stages, as shown in FIG. 1:
1. The creation of a users own content locker for unmatched content that does not reside in the catalogue of the said service (as disclosed in “Synchronising Unidentified Tracks”).
2. Synchronisation of metadata for the matched content against the said catalogue.

4.1 Playlist Reconstruction

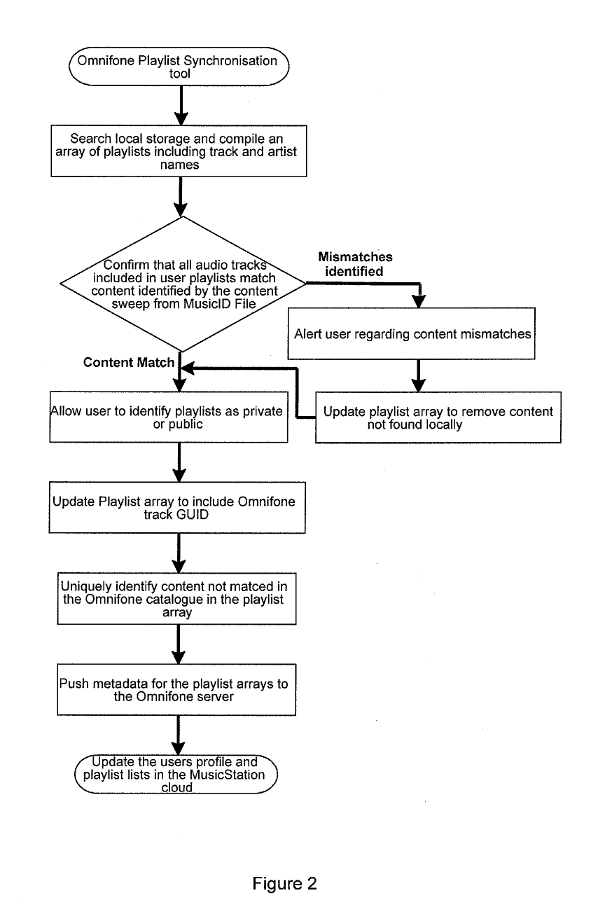

In the preferred embodiment, any playlists identified during the device sweep disclosed earlier would be reconstructed within the service within which the present invention is utilised. Specifically, playlist files, such as those in the form of *.M3U and *.pls and *.wpl files or any other appropriate playlist file format, would be duplicated, in the MusicStation Platform which forms one embodiment of the present invention, under the individual user's profile. That process is illustrated in FIG. 2.

Once the user's media content has been located and identified, as disclosed above, his affinity for specific tracks, artists and playlists may be calculated using the techniques disclosed in detail in Omnifone Patent Application “Nearest Neighbour & Digital Content Recommendation Techniques” PCT/GB2010/051113 or by any other compatible mechanisms.

Such a recommendations generation procedure, in the preferred embodiment, takes account both of the user's taste signature, as produced by the analysis of the user's “music collection” as derived from the device sweep disclosed earlier AND of the user's interaction history with the device to be synchronised.

As disclosed above, where any particular data is unavailable then demographically-derived metadata is, in the preferred embodiment, utilised in order to ensure that a set of media content is available for provisioning to the user's device even in the case where this is a new user with an empty device (as disclosed previously in this document, in the “Empty Devices” section).

6 Synchronisation of Channels

In the user interface for some device types the service within which the present invention is utilised may categorise media content into separate “channels”, as disclosed in detail in Omnifone Patent application: Channels and Radio stations PCT/GB2010/050771.

The user's preference for particular “channels” may be used to prioritise the downloading of—and, in the preferred embodiment, to weight the recommendations for—new media content, in combination with one or more of the other user-device interaction analyses, such as those disclosed in “Analyse User-Device Interaction” earlier.

In the preferred embodiment, such “channels” would be pre-populated with metadata and tracks where possible, the determination as to which are to be pre-emptively cached being based on one or more of the overall recommendations for the user, the type of network connection available, demographic data and editorial considerations, such as how to ensure that channels are populated evenly given the analysis already disclosed as to the user's listening preferences.

In the preferred embodiment, the end user would utilise the user interface of their client device to search for available channels and to subscribe to those channels in which he is interested (and to unsubscribe from channels to which he has previously been subscribed). In one example embodiment, the said user is permitted to maintain different sets of subscribed channels, with zero, one or more such channels sets being device-specific, permitting the said user to subscribe to, for example, different channels on each of his registered devices.

Where a channel is subscribed to by the said user, that user's registered client devices are, in the preferred embodiment, automatically updated with new content consistent with that channel's definition for the said user and the said device.

The initial selection of which channels to present—and, in the preferred embodiment, pre-load with some or all of that channel's defined content—to a given user on a given device is, in the preferred embodiment, made in a similar manner, mutatis mutandis, as for the mechanism used to provide track recommendations on the service within which the channels are utilised. In another example embodiment, the said initial selection of channels is made manually.

Channel-specific content is, in the preferred embodiment, stored securely on the client device using DRM protection appropriate to that device, and the synchronisation process for a channel includes the removal of stale channel content from the said device in order to free storage space for new channel content.

Where such channels are themselves grouped into “meta channels” then the preferred embodiment would treat the said meta channels similarly. In addition, in the preferred embodiment, empty channels are not displayed in the user interface.

7 Prioritise the Provision of Media Content to the Device

The provision of media content to the user's device requires, in the preferred embodiment, consideration of several factors, to whit:
Which of the media content in the user's music collection is to be provisioned. In the preferred embodiment, this is determined based on the user-device interaction analysis disclosed earlier.
Pre-Emptive caching of content: Which additional track recommendations are to be provisioned to the device. In the preferred embodiment, this is determined based on the overall recommendations analysis disclosed earlier.
When, and in what order, should such synchronisation take place. This may be determined based on an analysis of the device's connection history, as disclosed in “Device Connection Properties” earlier, or in another example embodiment synchronisation may take place at scheduled intervals.

In the preferred embodiment, synchronisation occurs as continuously as a device's connection type permits. Where possible, data is transmitted by “piggybacking” onto communications which would have happened anyway. For example, in one sample embodiment a device sends a “polling” communication to the server (of the service within which the present invention is utilised) at regular intervals. Where possible, other data—such as track playback metrics or metadata resulting from the device sweep disclosed earlier—will be sent simultaneously, thus making more efficient use of the available bandwidth.

Features of synchronisation include the following:
digital media files can be provided periodically to the device as collections of files divided by genre, by recommendation, by artist, by popularity or in any other fashion.
the order in which digital media files are provided to the device is determined by an analysis of the metadata concerning one or more of the user, the user's “taste signature”, recommendations obtained for the user and metadata concerning the device.
the user comprises a group of two or more users.
the “digital media files” consists of one or more of: individual digital media files, metadata describing digital media files, collections of digital media files or metadata describing collections of digital media files.
the device is a computer, a mobile device, a dedicated media player, a games console, a storage facility which is connectable via a network or any other device capable of playing or displaying digital media files or any combination of two or more of the foregoing.
the device comprises two or more devices which are linked, whether permanently, temporarily or intermittently, with one or more of: one another; one or more other devices or a remote server from which the service implementing the present invention operates.
different synchronisation priority orders can be associated with different devices.

1. A method for synchronising digital media content to a device, comprising the following steps:
(a) identifying a digital media collection linked to a given user;
(b) analysing the content of the digital media collection to derive a “taste signature” for that user;
(c) identifying, based on the “taste signature” analysis, the priority order in which media content files are to be provided to the device during a synchronisation;
(d) providing one or more media content files to the device during the synchronisation.

2. The method of claim 1, comprising the following steps:
(a) matching the “taste signature” to media content, whether within the user's music collection or in any broader collection of media content to which the user has access
(b) obtaining recommendations for the user based on that matching process;
(c) analysing the ways in which the user interacts with the device to be synchronised;
(d) identifying, based on the analyses, which media content files are to be provided to the device on synchronisation;
(e) identifying, based on the analyses, the priority order in which the media content files are to be provided to the said device during the synchronisation;
(f) providing one or more files to the device during the synchronisation.

3. The method of claim 1 where the digital media collection, including any associated metadata, is identified by locating and analysing digital media files on a device linked to the user.

4. The method of claim 1 where metadata relating to the digital media collection includes one or more of the following, whether or not that metadata is user-generated: titles; authors; composers; singers; publishers; genres; classifications; date-related information, including release dates; the locations of the digital media files; links between media, including playlists containing one or more digital media files; ratings; embedded tags; associated artwork; playback metrics; the duration of the digital media file; the size of the file, however measured; the file format; or any other descriptive metadata related to the digital media file.

5. The method of claim 1 where there are playback metrics obtained from analysing the ways in which the user interacts with the device to be synchronised and those playback metrics include metadata detailing one or more of: when the user has played or viewed the digital media file; where the user has played or viewed the digital media file; on which device or devices the user has played or viewed the digital media file; when the digital media file was made available to the user; how often the user has played or viewed the digital media file or any other metadata concerning the user's interactions with the digital media file.

6. The method of claim 1 where metadata relating to the digital media collection includes metadata derived from an analysis of a digital media file forming part of the collection, including metadata derived from Digital Signal Processing of the file.

7. The method of claim 1 where the “taste signature” is derived by an analysis of the metadata retrieved about the digital media collection, whereby one or more metadata items are aggregated across multiple files in the collection to identify the digital media preferences of the user.

8. The method of claim 1 where the analysis includes an analysis of metadata about the user, comprising one or more of the user's: age; location; income; religious beliefs or absence thereof; political leanings; education level; occupation; gender; sexuality; social class classification, however defined or derived; hobbies; other devices used by the user; the user's interactions with one or more devices; or any other relevant metadata concerning the user.

9. The method of claim 1 where metadata about the user's interactions with his devices comprises one or more of: digital media content which the user has specifically placed, or asked to be placed, on a device; the way in which the user interacts with device user interfaces; playback metrics for digital media items played or viewed by the user; or any other relevant metadata about the user's interactions with his device(s).

10. The method of claim 1 where metadata about the user is enhanced or produced by extrapolation based on known information about the user and other individuals within one or more groups of users to which the user is linked, including but not limited to other owners of the device type(s) owned by the user.

11. The method of claim 1 where analysing metadata about the user and his digital media files is augmented by adding weightings based on analyses of the metadata linked to other individuals to whom the user has chosen to link himself, including but not limited to, linked friends on a social networking service and recommendations made by those linked friends.

12. The method of claim 1 where the “taste signature” is further augmented by matching known data against data in one or more databases and thereby obtaining additional metadata beyond what was known directly from the examination of the digital media file or user-related metadata.

13. The method of claim 1 where metadata is updated periodically.

14. The method of claim 1 digital media content is placed on the device or in specific areas of the device's user interface based on an analysis of one or more of: the user's derived “taste signature”, metadata concerning the user's interactions with one or more devices; metadata about the device's environment, including but not limited to the device's charging status, location, power level or connectivity speed; or any other relevant considerations.

15. The method of claim 1 where digital media files are provided periodically to the device as collections of files divided by genre, by recommendation, by artist, by popularity or in any other fashion.

16. The method of claim 1 where the order in which digital media files are provided to the device is determined by an analysis of the metadata concerning one or more of the user, the user's “taste signature”, recommendations obtained for the user and metadata concerning the device.

17. The method of claim 1 where the said user comprises a group of two or more users.

18. The method of claim 1 where the “digital media files” consists of one or more of: individual digital media files, metadata describing digital media files, collections of digital media files or metadata describing collections of digital media files.

19. The method of claim 1 where the device is a computer, a mobile device, a dedicated media player, a games console, a storage facility which is connectable via a network or any other device capable of playing or displaying digital media files or any combination of two or more of the foregoing.

20. The method of claim 1 where the device comprises two or more devices which are linked, whether permanently, temporarily or intermittently, with one or more of: one another; one or more other devices or a remote server from which the service implementing the present invention operates.

21. The method of claim 20 where different synchronisation priority orders are associated with different devices.

22. A System for synchronising digital media content to a device, in which the system is operable to:
(a) identify a digital media collection linked to a given user;
(b) analyse the content of the digital media collection to derive a “taste signature” for that user;
(c) identify, based on the “taste signature” analysis, the priority order in which media content files are to be provided to the device during a synchronisation;
(d) provide one or more media content files to the device during the synchronisation.
